(19) United States
(12) Patent Application Publication
(10) Pub. No.: US 2007/0013882 A1
(43) Pub. Date: Jan. 18, 2007

(54) Method of manufacturing projection objectives and set of projection objectives manufactured by that method

(75) Inventors: Aurelian Dodoc, Oberkochen (DE); Wilhelm Ulrich, Aalen (DE); Heiko Feldmann, Schwaebish Gmuend (DE)

Correspondence Address: SUGHRUE MION, PLLC, 2100 PENNSYLVANIA AVENUE, N.W., SUITE 800, WASHINGTON, DC, 20037, US

(73) Assignee: CARL ZEISS SMT AG

(21) Appl. No.: 11/447,996

(22) Filed: Jun. 7, 2006

Related U.S. Application Data
(60) Provisional application No. 60/687,877, filed on Jun. 7, 2005.

(51) Int. Cl. G03B 21/00

(52) U.S. Cl. 353/122

(57) ABSTRACT

In a method of manufacturing projection objectives including defining an initial design for a projection objective and optimizing the design using a merit function, a set of related projection objectives including a first projection objective and at least one second projection objective is defined. Further, a plurality of merit function components, each of which reflects a particular quality parameter, is defined. One of these merit function components defines a common module requirement requiring that the first projection objective and the second projection objective each include at least one common optical module that is constructed to be substantially identical for the first and the second projection objective. The method results in a set of projection objectives having at least one common optical module. Employing the method in the manufacturing of complex projection objectives, such as projection objectives for microlithography, facilitates the manufacturing process and allows substantial cost savings.

This application claims benefit of provisional application U.S. Ser. No. 60/687,877 filed on Jun. 7, 2005. The complete disclosure of this provisional application is incorporated into the present application by reference.

### BACKGROUND OF THE INVENTION

1. Field of the invention

The present invention relates to a method of manufacturing projection objectives including defining an initial design for a projection objective and optimizing the design using a merit function. The method is used in the manufacturing of projection objectives, for example those used in a microlithographic process of manufacturing miniaturized devices.

2. Brief Description of the Related Art

Microlithographic processes are commonly used in the manufacture of miniaturized devices, such as integrated circuits, liquid crystal elements, micro-patterned structures and micro-mechanical components. In that process, a projection objective serves to project patterns of a patterning structure (usually a photo mask (mask, reticle)) onto a substrate (usually a semiconductor wafer). The substrate is coated with a photosensitive layer (resist) which is exposed with an image of the patterning structure using projection radiation.

In order to create even finer structures, it is sought to both increase the image-side numerical aperture (NA) of the projection objective and to employ shorter wavelength, preferably ultraviolet radiation with wavelength less than about 260 nm. As a consequence, increasingly high demands are placed on the complexity of the projection objective. A projection objective usually has a plurality of at least 10 or 20 or even 25 optical elements, such as lenses, curved mirrors and the like. Each single optical element as well as the entire structure containing the plurality of optical elements arranged in a certain way must be designed and manufactured to a high accuracy to provide an imaging of the patterning structure onto the substrate within a large image field and with a low level of aberrations.

Generating a new design of a projection objective is a complicated task involving an optimization of structural parameters and quality parameters of the projection objective. The structural parameters include refractive indices of materials of which the lenses are formed, surface shape parameters of lenses and mirrors (if applicable), distances between first and second surfaces of each lens, distances between surfaces of different optical elements, a distance between the object plane of the projection objective and an entry surface of the object-side front element of the projection objective, a distance between an exit surface of an image-side front element of the projection objective and the image plane, refractive indices of media disposed between adjacent optical elements, between the object plane and the object-side front element and between the image plane and the image-side front element.

Quality parameters include parameters describing the optical performance of the projection objective e.g. in terms of selected aberrations, image-side numerical aperture, magnification of the projection objective and the like.

In the patent U.S. Pat. No. 5,067,067 a method of manufacturing optical systems is disclosed where manufacturing considerations, such as design simplicity, glass cost, lens centerability, and manufacturability of aspheric surfaces are taken into account in the design process.

The optimization of a design to conform to a desired specification of the optical performance and other quality features of the projection objective nowadays involves computational methods such as ray tracing to optimize the parameters of the projection objective while observing certain boundary conditions. CODE V, a lens analysis and design program sold by Optical Research Associates, Inc., is a commonly used software tool employed for that purpose. The optimization includes minimizing or maximizing a suitably chosen merit function depending on the parameters of the design. Typically, the merit function construction is done by utilizing several merit function components, which may represent optical aspects, manufacturability aspects and other aspects describing the optimization goal of the specific design.

Due to the high number of parameters of the design, the solution space of the optimization process has high dimension, and there are many local minima and maxima in that solution space where a computational method might get trapped yielding a result far away from a design fulfilling the required specification. Therefore, an optics designer designing a projection objective for microlithography has to fulfill a sophisticated task to determine principles of a new design suitable for a certain application based on his or her intuition. A designer will therefore specify an “initial design” serving as a potentially successful “starting point” for a computer based optimization and will then improve the design based thereon by computational optimization. Typically, one or more results will still be insufficient with respect to a desired overall specification such that many efforts will have to be tried until a satisfactory solution is found. Therefore, the costs of a new design in the phase of computational manufacturing may be high.

Once a suitable design has been found, the optical elements of the projection objective have to be manufactured and assembled in order to obtain the actual product of the manufacturing process. Typically, in complex optical systems, such as projection objectives for microlithography, each optical element is mounted in a separate mount and the mounts are then assembled to obtain a barrel or casing containing the optical elements of the optical system in the specified arrangement. Typically, assembly of an optical system becomes more difficult with increasing complexity of the optical system in terms of components which have to be mounted together to obtain the complete optical system. Also, it becomes more difficult to obtain a desired optical performance the more single mounting steps are involved in manufacturing an optical system, since typically each mounting step will introduce a certain amount of inaccuracy contributing to optical aberrations.

### SUMMARY OF THE INVENTION

It is one object of the invention to provide a method of manufacturing projection objectives that allows to manufacture complex projection objectives for microlithography, in a cost effective way while maintaining high standards with respect to optical performance.

As a solution to this and other objects, this invention, according to one formulation, provides a method of manufacturing projection objectives including the steps of defining an initial design for a projection objective and optimizing the design using a merit function comprising:
defining a set of related projection objectives including a first projection objective and at least one second projection objective;
defining a plurality of merit function components, each of which reflects a particular quality parameter,
wherein one of the merit function components defines a common module requirement requiring that the first projection objective and the second projection objective each include at least one common optical module that is constructed to be substantially identical for the first and the second projection objectives,
where an optical module is a structure including at least two optical elements combined to perform a defined optical function;
computing a numerical value for each of the merit function components based on a corresponding feature of a preliminary design of the projection objectives;
computing from the merit function components an overall merit function expressible in numerical terms that reflect quality parameters;
successively varying at least one structural parameter of the projection objectives and recomputing a resulting overall merit function value with each successive variation until the resulting overall merit function reaches a predetermined acceptable value;
obtaining the structural parameters of the optimized projection objectives having the predetermined acceptable value for the resulting overall merit function; and
implementing the parameters to make at least one of the first and the second projection objectives.

In this method, the first projection objective and second projection objective are designed to perform distinctly different optical functions. Therefore, the sets of quality parameters related to the optical function vary significantly between the first and the second projection objectives.

Preferably, the first projection objective and the second projection objective are both configured as projection objectives suitable for micro-lithography for imaging a pattern provided in an object surface of the projection objective onto an image surface of the projection objective.

For example, the first projection objective may be specified as a “dry system” or “dry objective”, where in the image space between the exit surface of a last optical element and the image plane there is a finite working distance which, during operation, is filled with air or another suitable gas, such as Helium or Nitrogen, having a refractive index n≈1. The second projection objective, in contrast, may be specified as an “immersion system” or “immersion objective” suitable for immersion lithography. In one variant of this type an immersion medium with a refractive index substantially larger than 1 is introduced into an interspace between the exit surface of a last optical element of the projection objective and the image plane, where an entry surface of the substrate can be placed.

Whereas in dry objectives the image side numerical aperture is limited to values NA≦1, for example 0.8≦NA≦0.95, immersion lithography allows to obtain image side numerical apertures NA>1, for example NA=1.1 or 1.2 or 1.3 or larger. Alternatively, or in addition, the image field size may differ significantly between the first optical system and the second optical system.

When designing sets of projection objectives for different purposes, the invention allows to use synergy effects in the computational phase of the manufacturing process as well as in the manufacturing and assembly of the optical elements once the desired optical design has been found.

The first and second projection objective of the set of related projection objectives are related in that each of that projection objectives includes at least one optical module that is also present in the other projection objective of the set. This optical module is denoted “common optical module” in this specification. Generally, an “optical module” is a structure including at least two optical elements combined in a predefined arrangement to perform a defined optical function.

Although the physical structure of the optical module is substantially (essentially) the same in both projection objectives, the optical function of the optical module will generally differ between the projection objectives depending on the design and arrangement of the other optical elements of the respective projection objectives. Although the common optical module will typically have different optical functions in different optical environments, i.e. in different projection objectives of the set, the same mechanical mounting technique can be used for mounting the optical elements. Moreover, the same technologies can be used to manufacture the optical surfaces of the optical elements (spheric or aspheric) and for testing the single optical elements of the modules (component testing) as well as the entire optical module (system testing). Further, if identical modules can be used in different projection objectives of a set, logistic aspects, such as packaging, transport and so on can be facilitated. The overall costs for providing the projection objectives can therefore be drastically reduced.

In preferred embodiments the common optical module includes three or more consecutive optical elements, for example four, five, six, seven, eight, nine or ten optical elements. The optical elements may be lenses only. It is also possible that the optical elements include one or more reflective components, such as at least one concave mirror and/or another curved or planar mirror.

The term “common optical module” as used here is intended to encompass optical modules where the corresponding optical elements (e.g. lenses or mirrors) differ from each other no more than would be expected as a result of manufacturing tolerances, e.g. regarding surface shape, thickness of lenses, variations in refractive index etc. If aspheric surfaces are present in the common optical module, the correspnding aspheric surfaces should be similar in a sense that they can be tested using the same testing system.

With regard to absolute and relative positions of optical elements in a “common optical module”, a common optical module has “substantially the same construction” in two projection objectives of a set particularly if distances between corresponding optical elements do not differ by more than 2 mm between the projection objectives.

A common optical module may include at least one adjustable optical element intended and designed as a manipulator to adjust optical properties of the module. The manipulator may be used to at least partly adjust the common optical module to different installation environments and/or to different functions within the different projection objectives of a set. The manipularor may include at least one of at least one optical element displaceable parallel to the optical axis, at least one optical element displaceable transverse to the optical axis, particularly perpendicular thereto, at least one optical element tiltable about a tilting axis transverse, particularly perpendicular to the optical axis, and at least one deformable optical element associated to a driving system to provide a force or torque to actively deform that optical element such that the optical effect of that optical element is significantly changed.

Typically, the potential savings in costs and efforts are higher the higher the number of optical elements within a common optical module is when compared to the overall number of optical elements in an optical system. In preferred embodiments, the common optical module includes at least 20% of all optical elements of the projection objectives, or even at least one third of all optical elements.

Unlike in zoom objectives, where optical modules including one or more lens are necessary to allow relative movement of optical elements of the optical system with respect to each other, the common optical module is preferably mounted at a fixed position in the projection objective such that the relative position of the common optical module with respect to the other optical elements or the projection objective is fixed.

### BRIEF DESCRIPTION OF THE DRAWINGS

FIG. 1 shows a schematic representation of a catadioptric projection objective having a first, refractive subsystem, a second catadioptric subsystem and a third refractive subsystem (R-C-R type) in various combinations of subsystems forming a dry objective with NA<1 in 1(a) and an immersion objective with NA>1 in 1(b) to 1(d);

FIG. 2 shows a schematic lens section through a refractive two-belly projection objective having a sequence of negative (N) and positive (P) lens groups;

FIG. 3 shows a schematic representation of a refractive projection objective consisting of two consecutive groups of lenses, where 3(a) shows a dry objective with NA<1 and 3(b) shows an immersion objective with NA>1;

FIG. 4 shows diagrams indicating contributions of the lens groups of the system shown in FIG. 2 to spherical aberration in 4(a), coma in 4(b) and image field curvature in 4(c); and

FIG. 5 shows lens sections through two optical systems of a set of a related optical systems sharing a common optical module (shaded), where 5(a) shows an immersion objective having NA=1.05 and 5(b) shows a dry objective having NA=0.93.

### DETAILED DESCRIPTION OF THE PREFERRED EMBODIMENTS

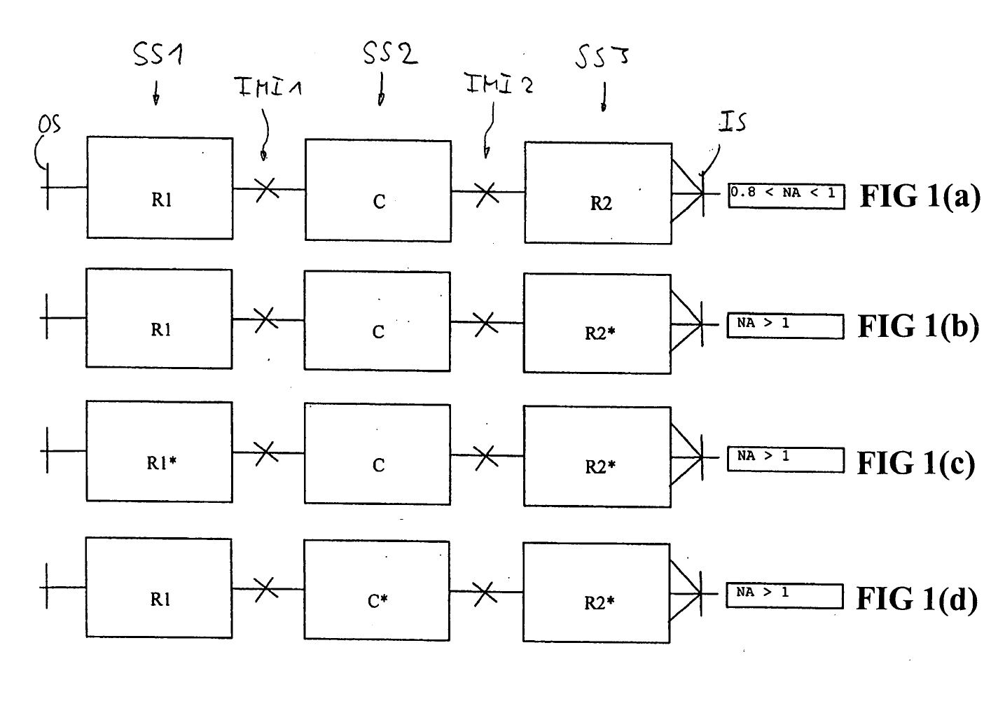

Some principles of the invention will now be explained with respect to FIG. 1, which shows schematic representations of related projection objectives of a set of projection objectives, where the projection objective is designed as a catadioptric projection objective for microlithography. The optical system is designed to project an image of a pattern on a reticle arranged in the planar object surface OS onto the planar image surface IS oriented parallel to the object surface on a reduced scale (e.g. 4:1) while creating exactly two real intermediate images IMI1, IMI2. The projection objective consists of three consecutive imaging subsystems SS1, SS2 and SS3 concatenated at the intermediate images and arranged in the sequence R-C-R, where “R” represents a refractive (dioptric) subsystem, “C” represents a catadioptric (or catoptric) subsystem and “-” represents the connection between the image subsystems at the intermediate image.

The first subsystem SS1 is a refractive (dioptric) subsystem (denoted R1 or R1*) designed to create the first intermediate image IMI1 from the object field such that the first intermediate image has a desired correction status, position and size suitable for further imaging by the subsequent imaging subsystems. In this respect, the first subsystem SS1 is a “relay system”. The second subsystem SS2 (designated C or C*) is a catadioptric or catoptric subsystem including exactly one concave mirror arranged optically between the first and second intermediate images close to or at a pupil surface. At least one additional lens is typically arranged within the second subsystem, providing negative refractive power close to the concave mirror. Positive refractive power optically closer to an intermediate image may also be provided. The second subsystem is designed to provide the major part of correction for image field curvature (Petzval sum) and longitudinal chromatic aberration (axial color, CHL). The second subsystem SS2 forms the second intermediate image IMI2 serving as the object of the third, refractive subsystem SS3 (denoted R2 or R2* in the figure). The third subsystem provides the major contribution to the overall reduction, thereby increasing the numerical aperture such that the substrate placed in the image surface IS is exposed with radiation, which, in the case of high aperture microlithographic projection objectives shown here, is typically in the range of NA>0.8.

The projection objective of FIG. 1(a) is a “dry objective” designed with respect to image aberration such that an image with low aberrations at image-side numerical aperture 0.8<NA<1 is obtained if an image-side working distance (finite gap between the exit surface of the projection objective and the image surface) is filled with a gas having refractive index n≈1. In contrast, the variants shown in FIG. 1(b) to (d) are “immersion objectives” providing image-side numerical aperture NA>1 if an immersion medium with refractive index no substantially larger than 1 is present in the space adjacent to the image surface. If a liquid immersion medium, such as pure water) is used as immersion medium, a small, finite image-side working distance is provided. The lens may also be designed as a “solid immersion lens” where a planar exit surface of the projection objective is placed either in contact with an entry surface of the substrate to be exposed or within a very small distance typically smaller than the wavelength of the projection radiation in order to allow image formation using evanescent fields exiting the projection objective (so called “near field lithography”).

Catadioptric projection objectives of type R-C-R consisting of a catadioptric subsystem arranged between an entry side and an exit side refractive subsystem are disclosed, for example, in U.S. application with a Ser. No. 60/573,533 filed on May 17, 2004 by the applicant. The disclosure of that application is incorporated into this application by reference. Other examples of R-C-R-Systems are shown in US 2003/0011755, WO 03/036361 or US 2002/0197946.

Intensive studies by the inventor revealed that it is possible to design dry objectives on the one hand and immersion objectives on the other hand in such a way that particular groups of subsequent optical elements can be used in identical form and arrangement in a dry objective (as shown in (a)) as well as in an immersion objective (as shown in (b) to (d)). For example, the projection objective of (a) and (b) are considered as first and second optical systems of a set of related optical systems. The difference in optical function of the projection objectives is brought about by replacing the second refractive subsystem R2 of the dry objective by a refractive subsystem of different design (designated R2*) in the immersion objective of (b). It has been found that the first refractive subsystem R1 (serving as relay optics) as well as the catadioptric subsystem (denoted “C”) can be left unchanged such that the first subsystem R1 as well as the second subsystem C each form a common optical module of the projection objectives shown in (a) and (b). In another view, the combination of the first refractive subsystem R1 and the subsequent catadioptric subsystem C having an intermediate image IMI1 therebetween can be regarded as one common optical module (which includes two immediately successive imaging subsystem linked at an intermediate image arranged therebetween).

In a transition from the dry objective of (a) to the variant of an immersion objective shown in (c) the catadioptric second subsystem (denoted C) is the common optical module present in both projection objectives, whereas the first, refractive subsystem R1 as well as the second, refractive subsystem R2 have different design in the dry objective and the immersion objective (denoted R1* and R2*, respectively).

In another variant shown in (d) the transition between the dry objective of (a) and the immersion objective of (d) is effected by exchanging the second, catadioptric subsystem C by subsystem C* and by exchanging the second refractive subsystem R2 by the refractive subsystem R2* having different design. Here, the relay system R1 forms the common optical module.

It has been found that the object-side first, refractive subsystem SS1 can normally be used as a common optical module for a dry system and a related immersion system. The main function of that relay system is to define the properties of the first intermediate image IMI1 with regard to position, size and correction status in such a way that the first intermediate image can be imaged onto the image surface by the subsequent subsystems. The second, catadioptric subsystem is basically responsible for providing a major contribution to the correction of image field curvature and longitudinal chromatic aberration. In the variants of (b) and (c) the catadioptric subsystem C is identical to the corresponding subsystem in the dry objective of (a), thereby forming a common optical module. The changing requirements for image field curvature and axial color correction caused by the change in numerical aperture NA can be compensated by modifying the image side refractive subsystem R2 when a transition is made from the dry objective to the immersion objective. Typically, one or more lenses having negative refractive power positioned appropriately in R2 are suitable for that purpose.

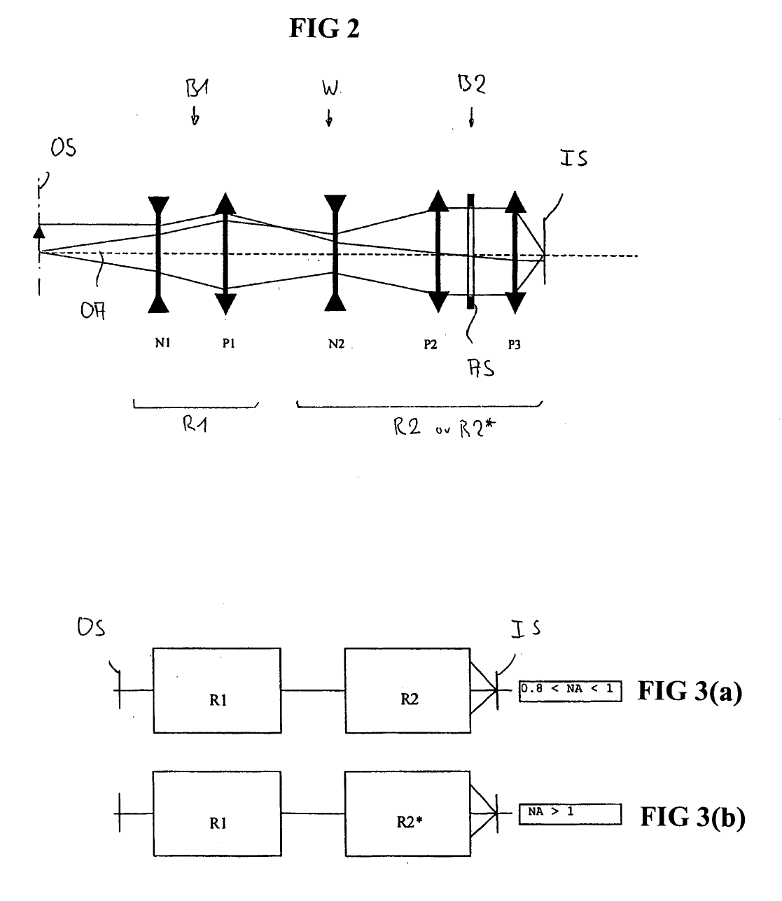

The invention can also be implemented in purely refractive projection objectives. Some refractive projection objectives suitable for immersion lithography have recently become known. Purely refractive projection objectives known from the international patent applications WO 03/077036 and WO 03/077037 A1 (corresponding to US 2003/3174408) of the applicant are designed as so-called “single-waist systems” or “two-belly systems” with an object-side belly, an image-side belly and a waist situated therebetween, that is to say a constriction of the beam bundle diameter. Image side numerical apertures up to NA=1.1 have been achieved in the mentioned embodiments. FIG. 2 shows a schematic lens section through a purely refractive, rotationally symmetric reduction objective designed for projecting a pattern, arranged in the object surface OS, of a reticle or the like onto the image surface IS on a reduced scale of e.g. 4:1 or 5:1. The single-waist system has five consecutive lens groups (represented by double-arrows) that are arranged along one straight optical axis OA which is perpendicular to the planar object surface and image surface. A first lens group N1 directly following the object surface has negative refractive power (symbolized by a double-arrow with arrow heads facing inside). A second lens group P1 following directly thereon has positive refractive power (symbolized by a double-arrow with arrow heads facing outside). A third lens group N2 following directly thereon has negative refractive power. A fourth lens group P2 following directly thereon has positive refractive power. A fifth lens group P3 following directly thereon has positive refractive power. The planar image surface (image plane) IS directly follows the fifth lens group such that the projection objective has no further lenses or lens groups apart from the first to fifth lens group. This distribution of refractive power provides a two-belly system that has an object side first belly B1, an image-side second belly B2, and a waist W lying therebetween, in which a constriction with minimum beam bundle diameter is positioned. In a transition region from the fourth lens group to the fifth lens group the system aperture is positioned in a region of relatively large beam diameters. An aperture stop AS is positioned in that region for adjusting the numerical aperture.

It is known that projection objectives of this type have potential for very high image side numerical apertures, where dry systems with 0.8<NA<1 as well as immersion objectives with NA>1 can be realized. Intensive studies of the inventor have revealed that it is possible to design a set of related projection objectives including a dry objective with 0.8<NA<1 as well as an immersion objective with NA>1 such that both objectives have a “common optical module”, i.e. a group of consecutive optical elements which are designed substantially the same in the dry objective and in the immersion objective.

FIG. 3 shows a schematic representation showing the dry objective in (a) and the related immersion objective (b). It has been found useful to design the objective such that the first two lens groups N1 and P1 on the object-side can be left unchanged in a transition from a dry objective to a immersion objective (or vice versa). These lens groups, identical in both objectives constitute common optical module R1 in FIG. 3. The remainder three lens groups N2, P2, P3 form a second optical module denoted R2 for the dry objective and R2* for the immersion objective. The type and sequence and/or number of lenses in the second optical module differ between the dry objective and immersion objective.

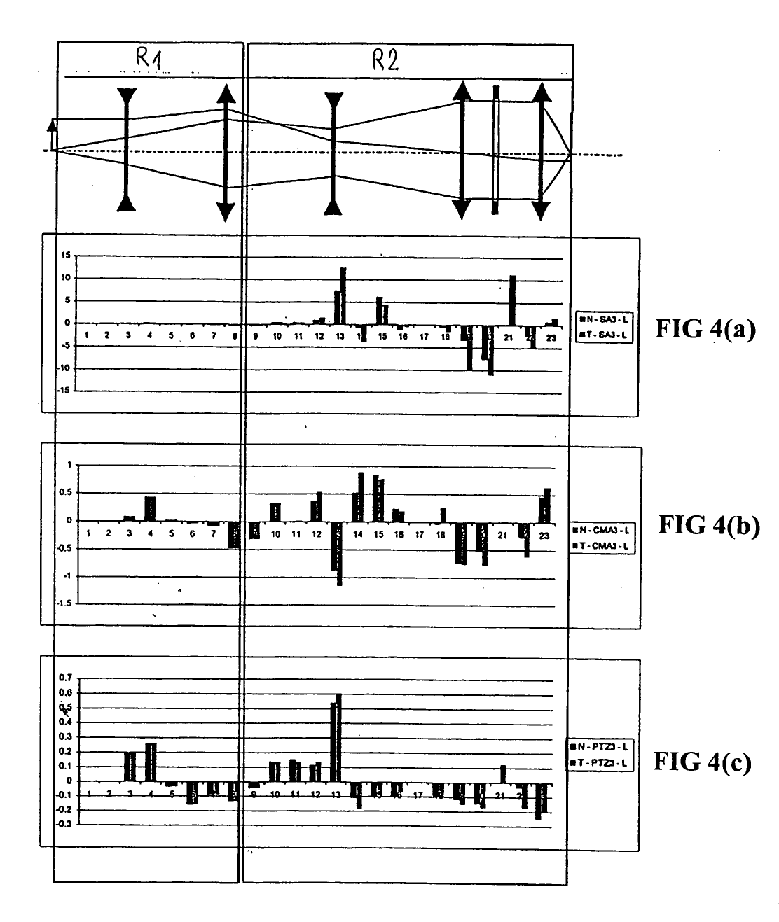

Considerable efforts were made to establish whether a common optical module can be designed at all and, if so, where an optimum interface position between a common optical module (identical in both objectives) and the variable optical modules (differing between both types of objectives) should be. In this embodiment, it has been found advantageous to position the interface such that maximum flexibility with respect to correction of spherical aberration, coma and image field curvature can be obtained. Analysis shows that these are the major image aberrations which differ significantly between an immersion objective having NA>1 and a dry objective having NA<1. For the purpose of demonstration, FIG. 4 shows the schematic representation of the single-waist system of FIG. 2 together with diagrams showing contributions of lenses and lens groups to spherical aberration (a), coma (b), and image field curvature (represented by the Petzval sum) in (c).

The diagrams in FIG. 4(a) to (b) show the lens contributions of spherical aberration (SA3), coma (COM3) and Petzval sum (PTZ) for both types of objectives at the smallest numerical aperture NA=0.93. It has been found that these are the aberrations which are most strongly effected by a transition between a dry objective and an immersion objective.

As FIG. 4(a) shows, the major contribution to spherical aberration correction originates from the three image side lens groups N2, P2 and P3 forming module R2. In contrast, there is almost no contribution to spherical aberration correction from the two image side lens groups N1 and P1. The situation is quite similar with regard to the correction of coma, where the lenses positioned around the waist W and the lenses around the system aperture provide the major contribution for correction. With regard to Petzval sum correction it is evident from FIG. 4(c) that a major contribution is generated in the region of the waist to counterbalance opposite contributions on the image side and on the object side thereof. Therefore, it was established that the two lens groups N1 and P1 closest to the object surface are preferred candidates for forming a common optical module, whereas lenses closer to the image surface and placed in the waist region must be modified in a transition between a dry objective and an immersion objective of this type.

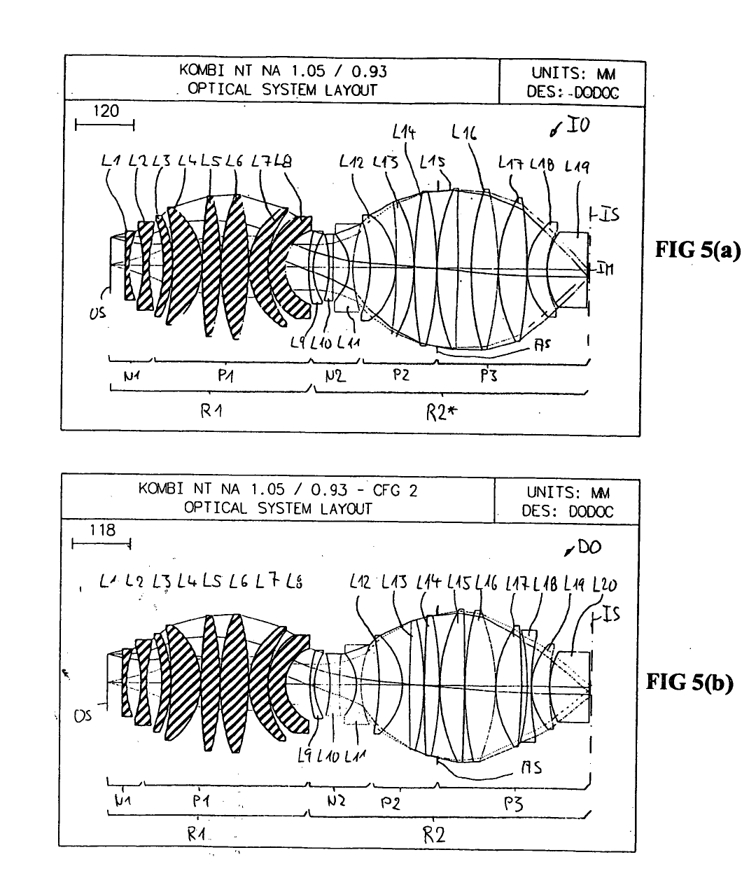

FIG. 5 shows operative examples of two objectives of a set of related objectives, where an immersion objective IO is shown in (a) and a corresponding dry objective DO shown in (b). Both objectives are designed for λ=248 nm operating wavelength and have 2 mm image side working distance. The image field size of the rectangular field is 26·10.5 mm² in both cases (differing image field sizes are also possible). The immersion objective in (a) is operated with an immersion liquid IM (water) inserted between a planar exit surface of the projection objective and the planar image surface IS at NA=1.05. In contrast, the finite gap between the exit surface of the objective and the image surface is filled air in (b) allowing numerical aperture NA=0.93.

The specifications of the designs are summarized in tabular form in tables 1(IM) and 1A(IM) for the immersion system and in table 1(DRY) and 1A(DRY) for the dry objective. In tables 1(IM) and 1(DRY) the leftmost column lists the number of the refractive, reflective, or otherwise distinguished surface, the second column lists the radius, r, of that surface [mm], the third column lists the distance, d [mm], between that surface and the next surface, a parameter that is referred to as the “thickness”, the fourth column lists the material employed for fabricating that optical element, the fifth column lists the refractive index of the material employed for its fabrication, and the sixth column lists the optically utilizable, clear, semi diameter [mm] of the optical component.

In both embodiments, a number of surfaces are aspherical surfaces. Tables 1A(IM) and 1A(DRY) list the associated data for those aspherical surfaces, from which the sagitta or rising height p(h) of their surface figures as a function of the height h may be computed employing the following equation:
p(h)=[((1/r)h²)/(1+SQRT(1−(1+K)(1/r)²h²))]+C1·h⁴+C2·h⁶+ . . . ,
where the reciprocal value (1/r) of the radius is the curvature of the surface in question at the surface vertex and h is the distance of a point thereon from the optical axis. The sagitta p(h) thus represents the distance of that point from the vertex of the surface in question, measured along the z-direction, i.e., along the optical axis. The constants K, C1, C2, etc., are listed in Tables 1A(IM) and 1A(DRY).

Both systems can be physically and optically subdivided into two parts, wherein in object-side common optical module R1 is identical in both systems, whereas the lenses following the common optical module towards the image surface form refractive optical modules R2 and R2* respectively, differing significantly in construction. The common optical module consists of the first, most object wise lens group N1 with negative refractive power and subsequent lens group P1 with positive refractive power. Lens group N1 consists of an image side negative lens L1 with almost planar entry surface and concave exit surface, followed by a biconcave negative lens L2. Positive lens group P1 consists of an entry side positive meniscus lens L3 with object side concave surface, a subsequent positive meniscus lens L4 with object side concave surface, two subsequent biconvex positive lenses L5, L6, a positive meniscus lens L7 having image-side concave surface and a meniscus lens L8 having image side concave surface and weak negative refractive power.

The subsequent module R2* in the immersion system IO has, in that sequence, a negative meniscus lens L9 having image side concave surface, a negative lens L10 near the position of minimum beam diameter, a biconcave negative lens L11, a positive meniscus lens L12 having an object side concave surface, another positive meniscus lens L13 having object side concave surfaces, a biconvex positive lens L14 immediately ahead of the system aperture AS, a positive lens L15 having spherical entry surface and aspheric exit surface, two biconvex positive lenses L16, L17, a positive meniscus lens L18 having image-side concave surface, and a piano-convex lens L19 having spherical entry surface and planar exit surface immediately upstream of the image surface IS.

With regard to the optical function, the lenses of the common optical module R1 are predominately designed for correcting distortion and telecentricity. In the following optical module R2, the lenses of negative group N2 in waist area serve primarily to correct field curvature, coma and spherical aberration. Remarkably, all lenses L15 to L19 between the system aperture AS and the image surface have positive refractive power, thereby effecting large convergence angle of radiation on the image side allowing NA>1 at low aberration values.

In contrast, in the dry objective DO of FIG. 5(b) the optical module R2 designed for receiving radiation coming from the common optical module R1 and to form the image in the image surface opens with four lenses L9, L10, L11, L12, being of the same type as lenses L9, L10, L11, L12 in the immersion lens, but having different curvatures of their entry and exit side when compared to the lenses of the immersion objective. A biconvex positive lens L13 having aspheric entry surface and spherical exit surface is then followed by a biconvex positive lens L14 immediately ahead of the system aperture, which is positioned closer to the waist as in the corresponding immersion objective. Fifth lens group P3 opens with three consecutive biconvex positive lenses L15, L16, L17. A biconcave negative lens L18 following this positive refractive power serves primarily for correcting higher order of spherical aberration, coma and astigmatism. Note that no negative lens is present between the system aperture and the image surface in the corresponding immersion objective. A positive meniscus lens L19 having image side concave surface and a plano-convex lens L20 having spherical entry surface and planar exit surface are provided between negative lens L18 and the image surface.

A direct comparison of the structural features of the image side optical modules R2 and R2*, respectively reveals some characteristic differences. In the immersion objective of FIG. 5(a) it is evident that only positive lenses are present between the waist region (where the beam bundle diameter attains a local minimum at the negative lenses L9, L10, L11) and the image surface IS. This appears characteristic of immersion objectives with moderate numerical aperture, e.g. close to NA=1 Immersion systems sharing this feature are disclosed in international patent application PCT/EP03/111677 filed on Oct. 22, 2003 by the applicant. The disclosure of that application is incorporated herein by reference. In contrast, high aperture dry objectives, such as shown in FIG. 5(b) require correction means for correcting higher order spherical aberration, astigmastism and coma, partly induced by high incidence angles on the last lens element adjacent to the image surface (plano-convex lens L20). A suitable means for correcting these aberrations is a negative lens with high incidence angles and exit angles of radiation positioned at a location with relatively large marginal ray height and non-zero chief ray height. In the embodiment of FIG. 5(b) the biconcave negative lens L19 is provided for that purpose at a distance both from the image surface IS and from the pupil surface where the aperature stop AS is positioned. Further, the aspherical lens surfaces have a tendency towards stronger deformations in order to provide sufficient aspherical correction contributions.

The invention allows an economic manufacturing process for optical systems, where large economic benefits can be particularly obtained for complex projection objectives for microlithography, which usually include at least 15 or 20 or even more lenses which have to be mounted relative to another with high accuracy. Optical modules can be designed to form elements of a building set for projection objectives such that a projection objective can be assembled using a small number of optical modules rather than a considerably larger number of single optical elements to construct a projection objective of desired function. Projection objectives can be analyzed to identify corresponding lens groups which are identical or quite similar in construction between objectives designed for different functions. Then, an optical module can be selected and different projection objectives of a set can be reoptimized such that each of that projection objective contains at least one common optical module and the remainder of the optical elements of the projection objectives are designed such that they perform a complementary optical function which, in addition to the optical function of the optical module, provide the desired optical function of the entire optical system. A platform principle is thereby introduced into the manufacture of projection objectives. Optical modules which may be inserted into different types of projection objectives can, for example, be designed such that they provide, as a consequence of the layout and arrangement of optical elements integrated therein, a certain correcting function, e.g. by providing strong means for image field curvature correction or strong means for correction of chromatic aberrations. Based on optical modules, modular objective systems can be designed economically. Software routines allowing to identify and/or implement optical modules in the design of more complex optical systems, such as projection objectives for microlithography, will facilitate future manufacture of complex optical systems.

The above description of the preferred embodiments has been given by way of example. The individual features may be implemented either alone or in combination as embodiments of the invention, or may be implemented in other fields of application. Further, they may represent advantageous embodiments that are protectable in their own right, for which protection is claimed in the application as filed or for which protection will be claimed during pendency of the application. From the disclosure given, those skilled in the art will not only understand the present invention and its attendant advantages, but will also find apparent various changes and modifications to the structures and methods disclosed. The applicant seeks, therefore, to cover all such changes and modifications as fall within the spirit and scope of the invention, as defined by the appended claims, and equivalents thereof.

TABLE 1
(IM)

| Sur- | | | | | ½ |
|---|---|---|---|---|---|
| face | Radius | Thickness | Material | 248.413 nm | Diameter |
| 1 | 0.000000 | −0.072693 | AIR | 1.00000000 | 64.573 |
| 2 | −1568.789661 | 7.997574 | SIO2V248 | 1.50885281 | 64.576 |
| 3 | 179.307329 | 28.903394 | N2VP950 | 1.00027962 | 68.537 |
| 4 | −239.139497 | 12.365315 | SIO2V248 | 1.50885281 | 71.344 |
| 5 | 240.999846 | 29.475445 | N2VP950 | 1.00027962 | 87.908 |
| 6 | −295.435206 | 18.864653 | SIO2V248 | 1.50885281 | 91.687 |
| 7 | −222.704490 | 0.995368 | N2VP950 | 1.00027962 | 100.305 |
| 8 | −487.550219 | 59.663902 | SIO2V248 | 1.50885281 | 110.866 |
| 9 | −140.510438 | 0.996298 | N2VP950 | 1.00027962 | 116.884 |
| 10 | 1032.321269 | 37.461425 | SIO2V248 | 1.50885281 | 138.690 |
| 11 | −548.511138 | 0.998331 | N2VP950 | 1.00027962 | 140.110 |
| 12 | 386.191635 | 57.490161 | SIO2V248 | 1.50885281 | 144.024 |
| 13 | −622.506816 | 0.997700 | N2VP950 | 1.00027962 | 143.235 |
| 14 | 132.978383 | 37.383993 | SIO2V248 | 1.50885281 | 117.701 |
| 15 | 163.622598 | 0.996878 | N2VP950 | 1.00027962 | 111.190 |
| 16 | 114.712308 | 37.102128 | SIO2V248 | 1.50885281 | 101.271 |
| 17 | 76.476917 | 51.643602 | N2VP950 | 1.00027962 | 73.679 |
| 18 | 316.074243 | 8.841198 | SIO2V248 | 1.50885281 | 72.421 |
| 19 | 124.873355 | 33.181993 | N2VP950 | 1.00027962 | 66.802 |
| 20 | −225.913541 | 7.995634 | SIO2V248 | 1.50885281 | 66.330 |
| 21 | −1327.805953 | 34.931398 | N2VP950 | 1.00027962 | 66.776 |
| 22 | −88.113887 | 8.049540 | SIO2V248 | 1.50885281 | 66.984 |
| 23 | 174.578294 | 39.260889 | N2VP950 | 1.00027962 | 87.783 |
| 24 | −222.318895 | 53.924677 | SIO2V248 | 1.50885281 | 91.654 |
| 25 | −125.994492 | 1.002701 | N2VP950 | 1.00027962 | 105.238 |
| 26 | −2199.468630 | 37.301168 | SIO2V248 | 1.50885281 | 132.598 |
| 27 | −278.591993 | 1.002786 | N2VP950 | 1.00027962 | 136.431 |
| 28 | 773.924176 | 46.632587 | SIO2V248 | 1.50885281 | 152.754 |
| 29 | −581.071531 | 3.645363 | N2VP950 | 1.00027962 | 154.105 |
| 30 | 0.000000 | 0.000000 | N2VP950 | 1.00027962 | 155.423 |
| 31 | 0.000000 | −2.518406 | N2VP950 | 1.00027962 | 155.423 |
| 32 | 408.098313 | 43.702061 | SIO2V248 | 1.50885281 | 159.975 |
| 33 | −1966.854092 | 27.972966 | N2VP950 | 1.00027962 | 159.696 |
| 34 | 560.565495 | 54.864023 | SIO2V248 | 1.50885281 | 160.030 |
| 35 | −506.420373 | 0.976063 | N2VP950 | 1.00027962 | 159.071 |
| 36 | 301.425947 | 59.017885 | SIO2V248 | 1.50885281 | 143.308 |
| 37 | −771.109601 | 0.996421 | N2VP950 | 1.00027962 | 139.750 |
| 38 | 00.000000 | 0.000000 | SIO2V248 | 1.50885281 | 128.777 |
| 39 | 00.000000 | 0.000000 | N2VP950 | 1.00027962 | 128.777 |
| 40 | 124.354764 | 38.279833 | SIO2V248 | 1.50885281 | 94.285 |
| 41 | 144.861269 | 1.410713 | N2VP950 | 1.00027962 | 79.139 |
| 42 | 126.842984 | 84.340472 | SIO2V248 | 1.50885281 | 74.643 |
| 43 | 0.000000 | 2.000000 | H2OV248 | 1.37831995 | 16.375 |
| 44 | 0.000000 | 0.000000 | AIR | 0.00000000 | 14.020 |

TABLE 1A
(IM)
Aspheric Constants

| SRF | 2 | 5 | 6 | 13 | 21 |
|---|---|---|---|---|---|
| K | 0 | 0 | 0 | 0 | 0 |
| C1 | 1.762082e−07 | −9.183634e−08 | −3.408842e−08 | −1.500515e−08 | 1.127039e−07 |
| C2 | −2.759343e−11 | −1.102652e−11 | −3.329749e−13 | 2.780276e−13 | 1.111238e−12 |
| C3 | 2.019270e−15 | 1.690219e−15 | 7.575864e−17 | 7.828638e−18 | −3.911416e−16 |
| C4 | −2.728143e−19 | −1.904109e−19 | 1.115585e−21 | −2.049366e−22 | −7.973208e−20 |
| C5 | 1.912846e−23 | 1.250178e−23 | 3.086727e−25 | 7.458985e−28 | −2.663011e−26 |
| C6 | −8.094791e−28 | −4.350273e−28 | −3.363604e−29 | 6.905378e−32 | −2.455555e−27 |
| SRF | 23 | 26 | 33 | 35 | 41 |
| K | 0 | 0 | 0 | 0 | 0 |
| C1 | −1.732944e−07 | −2.550983e−08 | 3.634681e−10 | 5.751410e−09 | −6.234011e−08 |
| C2 | 7.577403e−12 | 6.612947e−13 | 4.221634e−13 | 3.010024e−14 | 7.109989e−13 |
| C3 | −4.469153e−16 | 2.051494e−18 | −2.553884e−18 | −2.922458e−19 | 2.225044e−16 |
| C4 | 2.812559e−20 | 1.694020e−22 | −1.591737e−22 | 1.024859e−23 | 9.462190e−21 |
| C5 | −1.483815e−24 | −9.918545e−27 | 5.564228e−27 | −4.178737e−28 | −1.041202e−24 |
| C6 | 3.233356e−29 | −4.711136e−32 | −7.404837e−32 | 1.770091e−32 | 1.697312e−28 |

TABLE 1A
(DRY)

| Surface | Radius | Thickness | Material | 248.413 nm | ½ Diameter |
|---|---|---|---|---|---|
| 1 | 0.000000 | −0.072693 | AIR | 1.00000000 | 63.657 |
| 2 | −1568.789661 | 7.997574 | SIO2V248 | 1.50885281 | 63.660 |
| 3 | 179.307329 | 28.903394 | N2VP950 | 1.00027962 | 67.093 |
| 4 | −239.139497 | 12.365315 | SIO2V248 | 1.50885281 | 70.138 |
| 5 | 240.999846 | 29.475445 | N2VP950 | 1.00027962 | 85.099 |
| 6 | −295.435206 | 18.864653 | SIO2V248 | 1.50885281 | 89.422 |
| 7 | −222.704490 | 0.995368 | N2VP950 | 1.00027962 | 97.768 |
| 8 | −487.550219 | 59.663902 | SIO2V248 | 1.50885281 | 107.211 |
| 9 | −140.510438 | 0.996298 | N2VP950 | 1.00027962 | 114.432 |
| 10 | 1032.321269 | 37.461425 | SIO2V248 | 1.50885281 | 133.267 |
| 11 | −548.511138 | 0.998331 | N2VP950 | 1.00027962 | 134.835 |
| 12 | 386.191635 | 57.490161 | SIO2V248 | 1.50885281 | 137.838 |
| 13 | −622.506816 | 0.997700 | N2VP950 | 1.00027962 | 136.683 |
| 14 | 132.978383 | 37.383993 | SIO2V248 | 1.50885281 | 113.546 |
| 15 | 163.622598 | 0.996878 | N2VP950 | 1.00027962 | 105.837 |
| 16 | 114.712308 | 37.102128 | SI02V248 | 1.50885281 | 97.416 |
| 17 | 76.476917 | 51.643602 | N2VP950 | 1.00027962 | 71.636 |
| 18 | 243.797872 | 8.221467 | SIO2V248 | 1.50885281 | 67.859 |
| 19 | 118.695868 | 32.198276 | N2VP950 | 1.00027962 | 62.684 |
| 20 | −229.848945 | 21.449544 | SIO2V248 | 1.50885281 | 61.674 |
| 21 | −17500.763773 | 33.930639 | N2VP950 | 1.00027962 | 61.163 |
| 22 | −88.133632 | 9.868811 | SIO2V248 | 1.50885281 | 61.503 |
| 23 | 129.878510 | 38.225149 | N2VP950 | 1.00027962 | 79.008 |
| 24 | −430.176656 | 48.625825 | SIO2V248 | 1.50885281 | 90.542 |
| 25 | −122.664976 | 14.863955 | N2VP950 | 1.00027962 | 97.516 |
| 26 | 1552.236460 | 29.760537 | SIO2V248 | 1.50885281 | 128.434 |
| 27 | −507.758891 | 0.997436 | N2VP950 | 1.00027962 | 131.180 |
| 28 | 2202.661441 | 31.295168 | SIO2V248 | 1.50885281 | 137.481 |
| 29 | −592.000509 | −14.590008 | N2VP950 | 1.00027962 | 139.744 |
| 30 | 0.000000 | 0.000000 | N2VP950 | 1.00027962 | 140.208 |
| 31 | 0.000000 | 15.640781 | N2VP950 | 1.00027962 | 140.208 |
| 32 | 333.156274 | 49.531474 | SIO2V248 | 1.50885281 | 152.296 |
| 33 | −3915.908064 | 0.997316 | N2VP950 | 1.00027962 | 151.995 |
| 34 | 606.546299 | 61.671577 | SIO2V248 | 1.50885281 | 150.470 |
| 35 | −321.412235 | 0.980027 | N2VP950 | 1.00027962 | 149.003 |
| 36 | 215.963312 | 52.019952 | SIO2V248 | 1.50885281 | 120.089 |
| 37 | −1147.010839 | 11.149517 | N2VP950 | 1.00027962 | 115.225 |
| 38 | −478.749713 | 7.984417 | SIO2V248 | 1.50885281 | 110.866 |
| 39 | 541.826809 | 1.013589 | N2VP950 | 1.00027962 | 98.626 |
| 40 | 122.099360 | 35.743898 | SIO2V248 | 1.50885281 | 84.625 |
| 41 | 384.307335 | 1.003817 | N2VP950 | 1.00027962 | 78.062 |
| 42 | 160.120700 | 79.558765 | SIO2V248 | 1.50885281 | 69.472 |
| 43 | 0.000000 | 2.000000 | AIR | 1.00000000 | 19.253 |
| 44 | 0.000000 | 0.000000 | AIR | 0.00000000 | 14.020 |

Aspheric Constants

| | SRF | | | | |
|---|---|---|---|---|---|
| | 2 | 5 | 6 | 13 | 21 |
| K | 0 | 0 | 0 | 0 | 0 |
| C1 | 1.762082e−07 | −9.183634e−08 | −3.408842e−08 | −1.500515e−08 | 1.591867e−07 |
| C2 | −2.759343e−11 | −1.102652e−11 | −3.329749e−13 | 2.780276e−13 | 3.825677e−12 |
| C3 | 2.019270e−15 | 1.690219e−15 | 7.575864e−17 | 7.828638e−18 | −1.796033e−16 |
| C4 | −2.728143e−19 | −1.904109e−19 | 1.115585e−21 | −2.049366e−22 | 2.579256e−20 |
| C5 | 1.912846e−23 | 1.250178e−23 | 3.086727e−25 | 7.458985e−28 | −2.598003e−23 |
| C6 | −8.094791e−28 | −4.350273e−28 | −3.363604e−29 | 6.905378e−32 | 8.580656e−29 |

SRF

| | 23 | 26 | 35 | 41 |
|---|---|---|---|---|
| K | 0 | 0 | 0 | 0 |
| C1 | −2.667246e−07 | −1.957192e−08 | −1.555637e−10 | −1.651093e−08 |
| C2 | 1.111079e−11 | 4.026507e−13 | 7.732355e−13 | 3.236859e−12 |
| C3 | −9.349555e−16 | 9.196348e−18 | −2.130155e−17 | 2.596274e−16 |
| C4 | 7.382941e−20 | 3.358355e−23 | 5.629071e−22 | −5.320359e−20 |
| C5 | −5.553334e−24 | 1.486969e−26 | −1.123450e−26 | 4.850036e−24 |
| C6 | 1.718260e−28 | −8.079874e−31 | 1.213043e−31 | −2.301345e−28 |

1. A method of manufacturing projection objectives including the steps of defining an initial design for a projection objective and optimizing the design using a merit function comprising:
defining a set of related projection objectives including a first projection objective and at least one second projection objective;
defining a plurality of merit function components, each of which reflects a particular quality parameter,
wherein one of the merit function components defines a common module requirement requiring that the first projection objective and the second projection objective each include at least one common optical module that is constructed to be at least substantially identical for the first and the second projection objective,
where an optical module is a structure including at least two optical elements combined to perform a defined optical function;
computing a numerical value for each of the merit function components based on a corresponding feature of a preliminary design of the projection objectives;
computing from the merit function components an overall merit function expressible in numerical terms that reflect quality parameters;
successively varying at least one structural parameter of the projection objectives and recomputing a resulting overall merit function value with each successive variation until the resulting overall merit function reaches a predetermined acceptable value;
obtaining the structural parameters of the optimized projection objectives having the predetermined acceptable value for the resulting overall merit function; and
implementing the parameters to make at least one of the first and the second projection objectives.

2. The method according to claim 1, wherein the first projection objective and the second projection objective are configured as projection objectives suitable for microlithography for imaging a pattern provided in an object surface of the projection objective onto an image surface of the projection objective.

3. The method according to claim 2, wherein the first projection objective is designed as a dry system having a finite distance between an image-side exit surface of the projection objective and an image surface of the projection objective, where the projection objective is optimized with respect to aberrations such that, during operation, an image space between the image-side exit surface and image surface is filled with a gaseous medium having a refractive index n≈1, and wherein the second projection objective is designed as an immersion system optimized with respect to aberrations such that an immersion medium with refractive index no substantially larger than 1 is present adjacent to an image surface of the second projection objective during operation.

4. The method according to claim 2, wherein the first projection objective is designed to have an image-side numerical aperture NA<1 and the second projection objective is designed to have an image-side numerical aperture NA>1 during operation.

5. A set of related projection objectives comprising:
a first projection objective;
at least one second projection objective,
wherein the first and second projection objectives are projection objectives suitable for microlithography for imaging a pattern provided in an object surface of the projection objective onto an image surface of the projection objective;
wherein the first and second projection objectives are designed to perform differing optical functions;
wherein the first projection objective and the second projection objective include at least one common module that is constructed to be at least substantially identical for the first and second projection objective,
where an optical module is a structure including at least two optical elements combined to perform a defined optical function.

6. The set according to claim 5, wherein the first projection objective is a dry system having a finite distance between an image-side exit surface of the projection objective and the image surface, where the projection objective is optimized with respect to aberrations such that, during operation, an image space between the image-side exit surface and image surface is filled with a gaseous medium having a refractive index n≈1, and wherein the second projection objective is an immersion system optimized with respect to aberrations such that an immersion medium with refractive index n≈1 substantially larger than 1 is present adjacent to the image surface during operation.

7. The set according to claim 5, wherein the first projection objective is designed to have an image-side numerical aperture NA<1 and the second projection objective is designed to have an image-side numerical aperture NA>1 during operation.

8. The set according to claim 5, wherein the first projection objective and the second projection objective is a concatenated optical system having a plurality of imaging subsystems concatenated at intermediate images such that an intermediate image formed by a imaging subsystem immediately upstream of the intermediate image forms the object of a subsequent imaging subsystem immediately downstream of the intermediate image, and wherein at least one of the imaging subsystems is the common optical module.

9. The set according to claim 8, wherein the first projection objective and the second projection objective have a first, refractive subsystem designed to create a first intermediate image from an object field, a second, catadioptric or catoptric subsystem including exactly one concave mirror for forming a second intermediate image from the first intermediate image, and a second refractive subsystem for imaging the second intermediate image onto the image plane.

10. The set according to claim 9, wherein the common optical module includes the first, refractive subsystem.

11. The set according to claim 9, wherein the first, refractive subsystem forms the common optical module.

12. The set according to claim 5, wherein the first projection objective and the second projection objective is a refractive projection objective for microlithography having an image-side numerical aperture NA>0.7.

13. The set according to claim 12, wherein the refractive projection objective comprises:
a first lens group immediately following the object surface and having negative refractive power;
a second lens group immediately following the first lens group having positive refractive power;
a third lens group immediately following the second lens group and having negative refractive power for generating a constriction of a light beam passing through the projection objective;
a fourth lens group immediately following the third lens group and having positive refractive power; and
a fifth lens group immediately following the fourth lens group and having positive refractive power;
wherein the common optical module includes at least one of the first lens group and the second lens group.

14. The set according to claim 5, wherein the common optical module includes at least three consecutive optical elements.

15. The set according to claim 5, wherein the common optical module includes at least 20% of all optical elements of the projection objectives.

16. The set according to claim 5, wherein the common optical module is mounted at the fixed position in the projection objective such that the relative position of the common optical module with respect to other optical elements of the projection objective is fixed.
